(19) United States
(12) Patent Application Publication
(10) Pub. No.: US 2026/0180701 A1
(43) Pub. Date: Jun. 25, 2026

(54) CHARACTERIZING SATELLITE BEAMS VIA PASSIVE MEASUREMENT OF TERRESTRIAL TRAFFIC

(71) Applicant: AT&T Intellectual Property I, L.P., Atlanta, GA (US)

(72) Inventors: David Beppler, Duluth, GA (US); Giovanni Vannucci, Red Bank, NJ (US)

(21) Appl. No.: 18/988,860

(22) Filed: Dec. 19, 2024

(51) Int. Cl. H04B 17/309; H04B 17/10; H04L 65/60

(52) U.S. Cl. CPC H04B 17/347; H04B 17/103; H04L 65/60

(57) ABSTRACT

A method includes sending, to a satellite of a non-terrestrial network, an instruction to lock into a radio frequency test band and channel as the satellite is passing over a testing area and to enter a co-channel receive mode, sending, to a user endpoint device that is located in the testing area, an instruction to lock into the radio frequency test band and channel and to initiate a continuous upload data stream to a base station of a terrestrial network, determining an I/Q component of the continuous upload data stream observed by the satellite, determining the I/Q component of the continuous upload data stream observed by the base station, correlating the I/Q component observed by the satellite with the I/Q component observed by the base station, and calculating an estimated link loss and a change in a gain of an antenna of the satellite based on the correlating.

The present disclosure relates generally to mobile networks and relates more particularly to devices, non-transitory computer-readable media, and methods for characterizing satellite beams via passive measurement of terrestrial traffic.

### BACKGROUND

In the field of mobile networking, non-terrestrial networks (NTNs) are networks for which at least a portion of the physical infrastructure is not anchored to the Earth's surface. NTNs stand in contrast to terrestrial networks (TNs), which are networks for which a majority, if not all, of the physical infrastructure is anchored to the Earth's surface. For instance, NTNs include satellite networks and networks that utilize unmanned aerial vehicles or high-altitude platform systems to provide broadband links, while TNs include Fourth Generation long term evolution (4G LTE) and Wi-Fi networks. NTNs are considered to be one of the major pillars of Fifth Generation (5G), Sixth Generation (6G), and next-generation mobile networks due to their ability to extend mobile network coverage to locations that are currently underserved by TNs.

### SUMMARY

In one example, the present disclosure describes a device, computer-readable medium, and method for characterizing satellite beams via passive measurement of terrestrial traffic. For instance, in one example, a method includes sending, to a satellite of a non-terrestrial network, a first instruction that instructs the satellite to lock into a radio frequency test band and channel as the satellite is passing over a testing area and to enter a co-channel receive mode, sending, to a user endpoint device that is physically located in the testing area, a second instruction that instructs the user endpoint device to lock into the radio frequency test band and channel and to initiate a continuous upload data stream to a base station of a terrestrial network while locked into the test band and channel, determining a measurement of an in-phase/quadrature component of the continuous upload data stream observed by the satellite while the satellite was in the co-channel receive mode, determining a measurement of the in-phase/quadrature component of the continuous upload data stream observed by the base station, correlating the in-phase/quadrature component observed by the satellite with the in-phase/quadrature component observed by the base station, and calculating an estimated link loss and a change in a gain of an antenna of the satellite of the non-terrestrial network based on the correlating.

In another example, a non-transitory computer-readable medium stores instructions which, when executed by a processor, cause the processor to perform operations. The operations include sending, to a satellite of a non-terrestrial network, a first instruction that instructs the satellite to lock into a radio frequency test band and channel as the satellite is passing over a testing area and to enter a co-channel receive mode, sending, to a user endpoint device that is physically located in the testing area, a second instruction that instructs the user endpoint device to lock into the radio frequency test band and channel and to initiate a continuous upload data stream to a base station of a terrestrial network while locked into the test band and channel, determining a measurement of an in-phase/quadrature component of the continuous upload data stream observed by the satellite while the satellite was in the co-channel receive mode, determining a measurement of the in-phase/quadrature component of the continuous upload data stream observed by the base station, correlating the in-phase/quadrature component observed by the satellite with the in-phase/quadrature component observed by the base station, and calculating an estimated link loss and a change in a gain of an antenna of the satellite of the non-terrestrial network based on the correlating.

In another example, a device includes a processor and a computer-readable medium storing instructions which, when executed by the processor, cause the processor to perform operations. The operations include sending, to a satellite of a non-terrestrial network, a first instruction that instructs the satellite to lock into a radio frequency test band and channel as the satellite is passing over a testing area and to enter a co-channel receive mode, sending, to a user endpoint device that is physically located in the testing area, a second instruction that instructs the user endpoint device to lock into the radio frequency test band and channel and to initiate a continuous upload data stream to a base station of a terrestrial network while locked into the test band and channel, determining a measurement of an in-phase/quadrature component of the continuous upload data stream observed by the satellite while the satellite was in the co-channel receive mode, determining a measurement of the in-phase/quadrature component of the continuous upload data stream observed by the base station, correlating the in-phase/quadrature component observed by the satellite with the in-phase/quadrature component observed by the base station, and calculating an estimated link loss and a change in a gain of an antenna of the satellite of the non-terrestrial network based on the correlating.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for characterizing satellite beams via passive measurement of terrestrial traffic, in accordance with the present disclosure;

FIG. 3 illustrates a flowchart of an example method for characterizing satellite beams via passive measurement of terrestrial traffic, in accordance with the present disclosure;

FIG. 4 illustrates a flowchart of an example method for characterizing satellite beams via passive measurement of terrestrial traffic, in accordance with the present disclosure; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure describes a device, computer-readable medium, and method for characterizing satellite beams via passive measurement of terrestrial traffic. As discussed above, non-terrestrial networks (NTNs) are networks for which at least a portion of the physical infrastructure is not anchored to the Earth's surface. NTNs stand in contrast to terrestrial networks (TNs), which are networks for which a majority, if not all, of the physical infrastructure is anchored to the Earth's surface. For instance, NTNs include satellite networks and networks that utilize unmanned aerial vehicles or high-altitude platform systems to provide broadband links, while TNs include Fourth Generation long term evolution (4G LTE) and Wi-Fi networks. NTNs are considered to be one of the major pillars of Fifth Generation (5G), Sixth Generation (6G), and next-generation mobile networks due to their ability to extend mobile network coverage to locations that are currently underserved by TNs. In one example of the present disclosure, an NTN may be used to extend the mobile coverage of an LTE or 5G network.

For instance, a mobile network operator may utilize an NTN to extend the coverage of a TN into a geographic area in which it may be impractical or infeasible to deploy the necessary TN infrastructure (such as a remote, uninhabited, or sparsely inhabited geographic area). In this case, the coverage of the TN may be extended using a direct cellular-to-satellite NTN. Direct cellular-to-satellite service may also enable rapid deployment of extended network coverage in emergency situations such as natural disasters, accidents, and the like, and can enhance commercial, emergency, and first responder broadband communication systems.

The satellites of NTNs typically have broad fields of view. Each satellite may include an antenna array that is configured to form beams to limit the satellite's coverage to a relatively small physical area within this field of view, where broadcast of radio energy by the satellite outside of this small physical area may be prohibited. However, it is difficult to characterize the accuracy (e.g., precise physical location in which radio energy beam is being broadcast) and roll-off (e.g., how quickly the strength of the radio energy signal drops moving away from the center of the beam) of an active satellite transmit beam without causing unintended interference.

Satellite and terrestrial coverage tend to mutually interfere. One reason for this is that, to support a direct connection from a subscriber's user endpoint device which uses commercially available cellular technology (e.g., 2G, LTE, 5G, 6G, or another cellular technology) to a satellite, the satellite may be required to use radio frequency bands that the user endpoint device is already designed to communicate with. Furthermore, the satellite may be required to use either unlicensed radio frequency bands or radio frequency bands that are licensed to the mobile network operator.

Use of radio frequency bands that are licensed to the mobile network operator may require co-channel operation of the TN and NTN systems, and both the TN and the NTN may experience interference if co-channel cellular signals are broadcast in the same geographic area, in adjacent or otherwise closely located geographic areas, or in adjacent channels that are co-located or in close proximity to the coverage area of the TN. Co-channel or adjacent channel interference may reduce the signal-to-interference-and-noise ratio (SINR) of both the TN signals and the NTN signals, which may in turn degrade the spectral efficiencies of the TN and the NTN and ultimately lead to poor quality of experience for subscribers on either or both networks. Direct measurement of SINR, however, is typically not possible without access to expensive equipment.

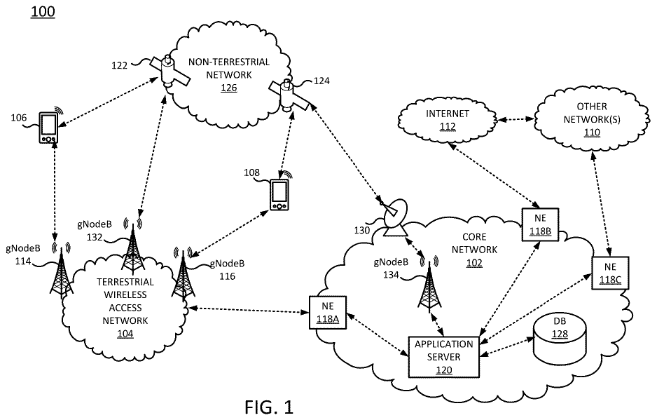

Examples of the present disclosure provide a way to indirectly estimate the coverage (e.g., accuracy and roll-off) of a satellite transmit beam, without requiring the satellite to broadcast the transmit beam to ground. In one example, the reciprocity of the satellite antenna pattern is leveraged to estimate the accuracy and roll-off. Within the context of the present disclosure, “reciprocity” as it relates to a satellite antenna pattern is understood to refer to the assumption that if the satellite pattern has a certain gain in a transmit mode (e.g., x degrees horizontal, y degrees vertical), then the gain will be similar in a receive mode. Because the satellite is not required to broadcast the transmit beam to ground, interference with a terrestrial network on the ground may be minimized. These and other aspects of the present disclosure are discussed in greater detail in connection with FIGS. 1-5, below.

To better understand the present disclosure, FIG. 1 illustrates an example network 100, related to the present disclosure. As shown in FIG. 1, the network 100 connects mobile devices 106 and 108, as well as potentially other devices, with one another and with various other devices via a core network 102, a wireless access network 104 (e.g., a cellular network), other networks 110 and/or the Internet 112.

In one example, wireless access network 104 may comprise a terrestrial network, such as a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 104 may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G (e.g., 6G) and further generations. While the present disclosure is not limited to any particular type of wireless access network, in the illustrative example, wireless access network 104 is shown as a UMTS terrestrial radio access network (UTRAN) subsystem. Thus, elements 114, 116, and 132 may each comprise a next generation Node B (gNodeB).

In one example, each of the mobile devices 106 and 108 may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like. In one example, any one or more of the mobile devices 106 and 108 may have both cellular and non-cellular access capabilities and may further have wired communication and networking capabilities.

As illustrated in FIG. 1, network 100 includes a core network 102. In one example, core network 102 may combine core network components of a cellular network with components of a triple play service network; where triple play services may include telephone services, Internet services and television services to subscribers. For example, core network 102 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise a broadcast television network, e.g., a traditional cable provider network or an Internet Protocol Television (IPTV) network, as well as an Internet Service Provider (ISP) network. The network elements 118A-118C may serve as gateway servers or edge routers to interconnect the core network 102 with other networks 110, Internet 112, wireless access network 104, other access networks, and so forth.

The core network 102 may also comprise an application server (AS) 120 and a database (DB) 128 that may be configured to monitor and store the locations and movements of satellites 122 and 124 of a non-terrestrial network 126, to collect in-phase/quadrature components of data transmissions observed by the satellites 122 and 124 and/or by cellular base stations 114, 116, 132, and 134 of the terrestrial wireless access network 104 and core network 102, to estimate link budget losses associated with beams emitted by antenna arrays of the satellites 122 and 124, and/or to send instructions to the satellites 122 and 124, the mobile devices 106 and 108, and/or the network elements 114, 116, and 132 to modify their operating parameters or conditions to facilitate characterization of the beams emitted by the antenna arrays of the satellites 122 and 124, as discussed in further detail below.

In one example, a cellular base station (e.g., a gNode B) 134 may communicatively couple the AS 102 to a satellite receiver 130 of the core network 102. The base stations 132 and 134 may be implemented within the satellites 122 and 124, respectively, or between the satellites and satellite receiver 130 and the core network 102 (e.g., the application server 120) to convert the analog waveforms of cellular transmissions into digital format in the downlink (and to make the opposite conversion for the uplink). For ease of illustration, various additional elements of core network 102 are omitted from FIG. 1. For instance, core network 102 may also include other network elements that are not illustrated, such as television (TV) servers, content servers, application servers, and the like.

In addition, the network 100 may include the non-terrestrial network 126 that functions in a manner similar to the terrestrial wireless access network 104. For instance, the non-terrestrial network 126 may comprise an access network that provides broadband links via satellite, unmanned aerial vehicles, high-altitude platform systems, or any other yet to be developed future wireless/non-terrestrial network technology. While the present disclosure is not limited to any particular type of non-terrestrial network, in the illustrative example, non-terrestrial network 126 is shown as a satellite network. Thus, elements 122 and 124 may each comprise a satellite, such as an LEO satellite. In one example, the non-terrestrial network 126 may be controlled and/or operated by a mobile network operator of the terrestrial wireless access network 104. In another example, the non-terrestrial network 126 may be controlled and/or operated by a different entity than the mobile network operator who operates the terrestrial wireless access network 104.

In one particular example, the non-terrestrial network 126 may utilize radio frequency bands that are also utilized by the terrestrial wireless access network 104 (e.g., radio frequency bands that are licensed by a mobile network operator who operates the terrestrial wireless access network 104). As such, the terrestrial wireless access network 104 and the non-terrestrial network 126 may operate in a co-channel arrangement.

In one example, the AS 120 may be configured to monitor the locations and movements (e.g., speed and trajectory of motion) of the satellites 122 and 124 and to send commands to the mobile devices 106 and 108 that cause the mobile devices to lock into test radio frequency bands or channels and to enter a co-channel data upload mode during times that one of the satellites 122 or 124 is expected to pass over a specified testing area in the network 100. The AS 120 may further collect data relating to the data upload stream between the mobile device 106 or 108 and a cellular base station 114, 116, or 132 in the terrestrial wireless access network 104. The data relating to the data transfer may include in-phase/quadrature components of the data upload stream that are observed by one of the satellites 122 or 124 and by the cellular base station 114, 116, or 132. Based on the data relating to the data upload stream, the AS 120 may estimate link budget losses of radio frequency energy beams emitted by an antenna array of the satellite 122 or 124.

As a more specific example, mobile device 108 may be a test device that is connected to the terrestrial wireless access network 104. The mobile device 108 may be placed at the edge of a cell of the terrestrial wireless access network 104 and may be locked into a test radio frequency band of the terrestrial wireless access network 104. The AS 120 may communicate the test radio frequency band to the mobile device 108.

The mobile device 108 may then establish a continuous data upload stream, via the terrestrial wireless access network 104, with a cellular base station 114, 116, or 132 of the terrestrial wireless access network 104. Data about the continuous data upload stream (e.g., observed in-phase/quadrature components of the carrier) may be communicated to the AS 120 by the cellular base station 114, 116, or 132. The AS 120 may store the data about the continuous data upload stream in the DB 128.

The AS 120 may also monitor the location and movement of the satellite 122 or 124 of the non-terrestrial network 126 and may estimate, based on the monitoring, when the satellite 122 or 124 is expected to pass over a testing area of the network 100. When the satellite 122 or 124 is expected to pass over the testing area, the AS 120 may send a command to the satellite 122 or 124 to lock into the test radio frequency band and to enter the co-channel receive mode.

Because the antenna of the mobile device 108 is omnidirectional, the continuous data upload stream may also be broadcast to one of the satellites 122 or 124 that is locked into the test radio frequency band (and is in a co-channel receive mode). Data about the continuous data upload stream (e.g., observed in-phase/quadrature components of the carrier) may be communicated to the AS 120 by the satellite 122 or 124. The AS 120 may store the data about the continuous data upload stream in the DB 128.

The AS 120 may correlate the data about the continuous upload data stream that is received from the cellular base station 114, 116, or 132 with the data about the continuous upload data stream that is received from the satellite 122 or 124. The correlation may be time based, which may allow the AS 120 to observe differences in the data (e.g., differences in amplitudes of in-phase/quadrature components) that was simultaneously observed by the cellular base station 114, 116, or 132 and the satellite 122 or 124. The differences in the data may help the AS 120 to estimate the link budget losses of the non-terrestrial network 126 as well as the coverage of the satellite 122 or 124.

Further, knowledge of where the satellite beam was pointed allows the AS 120 to compare the expected beam-center path loss to the measured path loss, and to calculate the change in satellite antenna gain at the terrestrial distance from the beam center. The difference of the gain of the antenna pattern (expressed as an angle from the center of the satellite beam) can then be determined by the AS 120 via analytical methods. Data from multiple passes/measurements/instances may be used as inputs to a large language model (LLM) or other AI tools to create a dataset which characterizes the pattern of the satellite antenna across its entire field of view.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Wireless access network 104 is not limited to a UMTS/UTRAN configuration. Non-terrestrial network 126 is not limited to a satellite network. Similarly, the present disclosure is not limited to an IP/MPLS network for VoIP telephony services, or any particular type of broadcast television network for providing television services, and so forth.

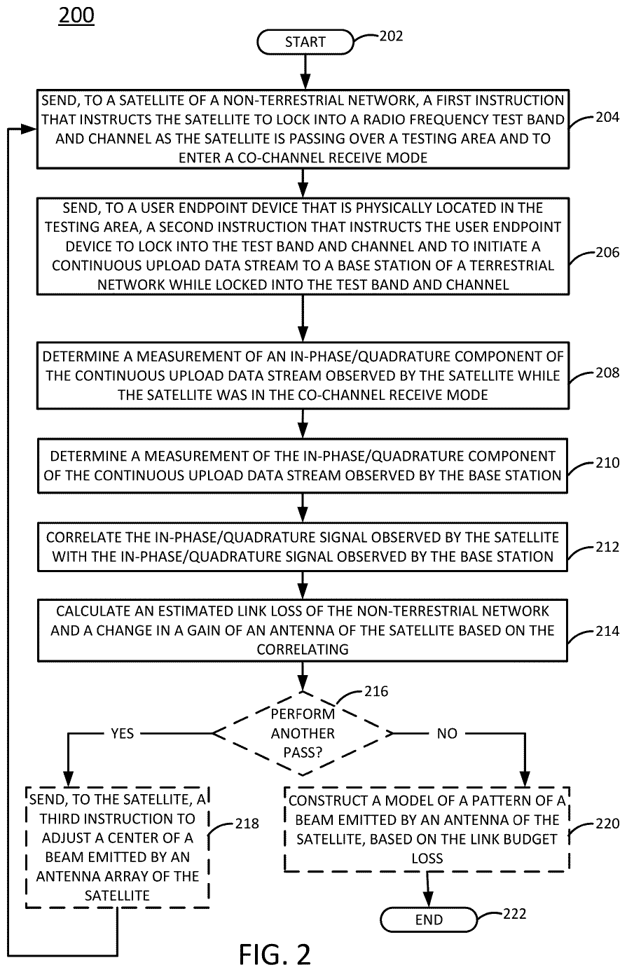

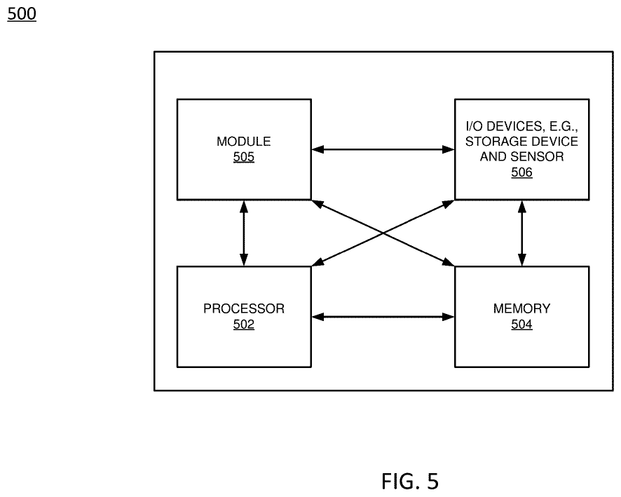

To further aid in understanding the present disclosure, FIG. 2 illustrates a flowchart of an example method 200 for characterizing satellite beams via passive measurement of terrestrial traffic, in accordance with the present disclosure. In one example, the method 200 may be performed by a network element management system or application server of a mobile network operator core network, such as the AS 120 illustrated in FIG. 1. However, in other examples, the method 200 may be performed by another device, such as a base station of a TN or the processor 502 of the system 500 illustrated in FIG. 5. For the sake of example, the method 200 is described as being performed by a processing system.

The method 200 begins in step 202. In step 204, the processing system may send, to a satellite of a non-terrestrial network, a first instruction that instructs the satellite to lock into a radio frequency test band and channel as the satellite is passing over a testing area and to enter a co-channel receive mode.

In one example, the processing system may be part of a network element management system or application server of a mobile network operator core network, where the mobile network operator core network may comprise a terrestrial network that is coupled to both terrestrial and non-terrestrial access networks. In this case, the satellite may comprise a portion of the physical infrastructure of a non-terrestrial access network, where the non-terrestrial access network may comprise a plurality of satellites including the satellite.

The satellite may include an antenna array that is configured to emit a beam of radio frequency energy. In one example, the testing area may encompass a defined physical location within the mobile network operator core network. The defined physical location may be covered by the broadcast area of the radio frequency beam emitted by the satellite for a period of time. A center of the antenna's gain pattern in this case may be earth-fixed (e.g., continuously aimed at the same physical location) or may sweep across an area including the testing area. Thus, the processing system may track movements of the satellite relative to the testing area in order to estimate when the satellite will pass over the testing area.

For instance, in cases where the satellite is a low Earth orbit (LEO) satellite, the terrestrial coverage area of the satellite may constantly change due to changes in the satellite's physical location and angular altitude as the satellite orbits the Earth's surface. Thus, the testing area may be within the terrestrial coverage area of the satellite at some times and outside the terrestrial coverage area of the satellite at other times. In one example, the processing system may detect when the testing area is within (or within some threshold distance or time period of being within) the terrestrial coverage area of the satellite (e.g., by detecting signals in the radio frequency bands that are emitted by the satellite). In another example, a remote application server or other devices may track the position of the satellite relative to the testing area and may send updates on the position of the satellite to the processing system.

In one example, a time at which the testing area is expected to be physically located within the terrestrial coverage area of the satellite may be estimated based on knowledge of at least one of: the physical location of the testing area, the current location of the satellite, the current trajectory of the satellite, or the current speed of motion of the satellite. In one example, the estimate may be generated using a machine learning algorithm (such as a support vector machine, a neural network, a Bayes network, a decision tree, or the like) that takes any one or more of the aforementioned parameters as input and generates as an output the time at which the testing area is expected to be physically located within the terrestrial coverage area of the satellite.

In one example, “locking” of the satellite into a radio frequency band involves “listening” for signals that are broadcast in the radio frequency band. In one example, the radio frequency test band comprises a radio frequency band that is licensed by a mobile network operator who operates the terrestrial network. As discussed in further detail below, the radio frequency band may also be utilized by a non-terrestrial network, such as a cellular-to-satellite NTN of which the satellite is a part.

In step 206, the processing system may send, to a user endpoint device that is physically located in the testing area, a second instruction that instructs the user endpoint device to lock into the radio frequency test band and channel and to initiate a continuous upload data stream to a base station of a terrestrial network while locked into the test band and channel.

In one example, the user endpoint device may comprise any subscriber/customer endpoint device configured for wireless communication, such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like. The user endpoint device may comprise any standard user endpoint device of these types, or may comprise a user endpoint device that is dedicated for assisting with satellite beam characterization.

In one example, the terrestrial network may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, the terrestrial network may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G and further generations.

In one example, the user endpoint device may be a test device operated by the mobile network operator that is physically located within a predefined distance of the edge of a cell that is served by the terrestrial network.

In one example, the continuous upload data stream may be initiated by the user endpoint device using any one or more known communication protocols to establish an upload data transfer session. In a further example, the continuous upload data stream may comprise at least one of: a voice session or a data session. For instance, the continuous upload data stream may involve a voice call, a data (e.g., multimedia) call, a data (e.g., video, audio, or the like) streaming session, a data transfer (e.g., multimedia upload) session, and/or another type of upload data stream.

In one example, the continuous upload data stream may be dynamically controlled by the user endpoint device to persist for a time period of sufficient duration to maintain at least a threshold data rate over the connection to the terrestrial network over the duration of transmission of the continuous upload data stream (where the threshold data rate may comprise an average data rate over the continuous upload data stream, a peak data rate, a minimum data rate, or the like). In another example, the duration of the continuous upload data stream may be predefined, in which case the duration may be a duration that is empirically determined to be of sufficient length to maintain at least the threshold data rate over the connection to the terrestrial network over the duration of the continuous upload data stream.

In one example, the continuous upload data stream may be automated to repeatedly upload a specified file, such as a test file of a defined size, using randomized data to prevent the automatic application of data compression techniques (which would reduce the demand on the connection to the terrestrial network).

In step 208, the processing system may determine a measurement of an in-phase/quadrature (I/Q) component of the continuous upload data stream observed by the satellite while the satellite was in the co-channel receive mode.

The in-phase (I) component of the I/Q signal is a cosine waveform, while the quadrature (Q) component of the I/Q signal is a sine waveform. As is known, a sine wave (without any additional phase) is shifted by ninety degrees relative to a cosine wave (or, the sine and cosine waves are said to be “in quadrature”).

In one example, the measurement of the I/Q component observed by the satellite may be determined by acquiring the measurement from at least one of: the satellite itself, a satellite receiver of the terrestrial network that is communicatively coupled to the satellite, or a base station of the terrestrial network that is communicatively coupled to the satellite.

In step 210, the processing system may determine a measurement of the in-phase/quadrature (I/Q) component of the continuous upload data stream observed by the base station.

In one example, the measurement of the I/Q component of the continuous upload data stream transmitted by the user endpoint device may be determined by acquiring the measurement from at least one of: the user endpoint device (e.g., a device log or an over-the-air transmission from the user endpoint device) or from a log of the base station.

In step 212, the processing system may correlate the in-phase/quadrature component observed by the satellite with the in-phase/quadrature component observed by the base station.

In one example, correlating the I/Q component observed by the satellite with the I/Q component observed by the base station involves aligning the I/Q component observed by the satellite with the I/Q component observed by the base station based on time. For instance, an I/Q component observed by the satellite at time t may be correlated with an I/Q component observed by the base station at time t (e.g., using timestamps of the observed I/Q components). By aligning the observed I/Q components based on time, this allows the processing system to observe whether the amplitude of the I/Q component observed by the satellite at a given time is similar to the amplitude of the I/Q signal observed by the base station at the same time.

In step 214, the processing system may calculate an estimated link loss and a change in a gain of an antenna of the satellite of the non-terrestrial network based on the correlating.

Link budget loss is the amount of power a radio frequency signal loses as the signal passes through a satellite communication system. In one example, the link budget loss may be estimated based on a difference in amplitude between an I/Q component observed by the satellite and an I/Q component observed by the base station at the same time, as described above. Reception of the I/Q signal allows direct measurement of the amplitude, and comparison of the I/Q signal to the recorded transmit signal, thereby allowing a calculation to be made (i.e., recorded transmit signal minus measured signal received equals link budget loss).

In optional step 216 (illustrated in phantom), the processing system may determine whether to repeat steps 204-214 during a subsequent pass of the satellite over the testing area.

In one example, the method 200 may be performed in multiple iterations, where each iteration of the method 200 may be performed with the center of the beam emitted by the satellite's antenna array adjusted to cover a different physical location on the ground. When multiple iterations of the method 200 are performed with different beam configurations, the data collected from the multiple iterations can be used to construct a model of the antenna pattern. The data collected from the multiple iterations may also help to characterize the edge of the beam (i.e., the point at which the gain decreases sharply). In one example, the number of iterations of the method 200 that are to be performed may be defined by a technician.

If the processing system determines in step 216 that another pass should be performed, then the method 200 may proceed to step 218. In optional step 218 (illustrated in phantom), the processing system may send, to the satellite, a third instruction to adjust a center of a beam emitted by an antenna array of the satellite.

Adjusting the center of the beam may cause a different physical location on the ground to be covered by the beam. Having adjusted the center of the beam emitted by the antenna array of the satellite, the method 200 may return to step 204, and the method 200 may proceed as described above to repeat steps 204-214 for the adjusted center of the beam.

If, however, the processing system determines in step 216 that another pass should not be performed (e.g., that sufficient data has been gathered over any previously performed passes), then the method 200 may proceed to step 220. In optional step 220 (illustrated in phantom), the processing system may construct a model of a pattern of a beam emitted by an antenna array of the satellite, based on the link budget loss.

In one example, machine learning techniques may be used to construct the model of the antenna pattern from the link losses that are measured. For instance, a machine learning technique such as a generative artificial intelligence technique (e.g., using a large language model, a small language model, or another type of generative technique) may be used to construct the model of the antenna pattern. In another example, a different machine learning technique, such as a support vector machine, a Bayes model, a neural network, a random forest model, or another type of machine learning model may be used. The method 200 may end in step 222.

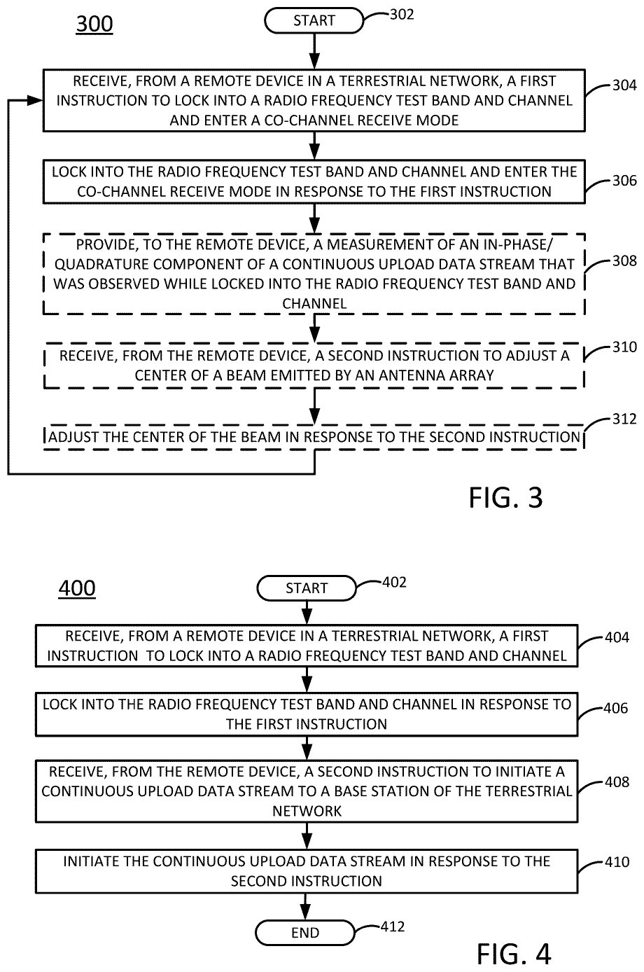

FIG. 3 illustrates a flowchart of an example method 300 for characterizing satellite beams via passive measurement of terrestrial traffic, in accordance with the present disclosure. In one example, the method 300 may be performed by a satellite of a non-terrestrial network, such as one of the satellites 122 or 124 illustrated in FIG. 1. However, in other examples, the method 300 may be performed by another device, such as the processor 502 of the system 500 illustrated in FIG. 5. For the sake of example, the method 300 is described as being performed by a processing system.

The method 300 begins in step 302. In step 304, the processing system may receive, from a remote device in a terrestrial network, a first instruction to lock into a radio frequency test band and channel and to enter a co-channel receive mode.

In one example, the processing system may be part of a satellite of a non-terrestrial network, such as a cellular-to-satellite NTN. The satellite may include an antenna array that is configured to emit a beam of RF energy.

In one example, the terrestrial network may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, the terrestrial network may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G and further generations.

In one example, the remote device in the terrestrial network may comprise a network element management system or application server of a mobile network operator core network.

In step 306, the processing system may lock into the radio frequency test band and channel and enter the co-channel receive mode in response to the first instruction.

In one example, “locking” of the processing system into the radio frequency test band involves “listening,” by the processing system, for signals that are broadcast in the radio frequency test band. In one example, the radio frequency test band comprises a radio frequency band that is licensed by a mobile network operator who operates the terrestrial network. As discussed in further detail below, the radio frequency band may also be utilized by the terrestrial network.

In optional step 308 (illustrated in phantom), the processing system may provide, to the remote device, a measurement of an in-phase/quadrature component of a continuous upload data stream that was observed while locked into the radio frequency test band and channel.

In one example, the processing system may provide the measurement of the I/Q component directly to the remote device. In another example, the processing system may provide the measurement of the I/Q component indirectly to the remote device, via a satellite receiver in the terrestrial network.

As discussed above, the in-phase (I) component of the I/Q signal is a cosine waveform, while the quadrature (Q) component of the I/Q signal is a sine waveform. As is known, a sine wave (without any additional phase) is shifted by ninety degrees relative to a cosine wave (or, the sine and cosine waves are said to be “in quadrature”).

In optional step 310 (illustrated in phantom), the processing system may receive, from the remote device, a second instruction to adjust a center of a beam emitted by an antenna array.

As discussed above, the method 300 may be performed in multiple iterations, where each iteration of the method 300 may be performed with the center of the beam emitted by the satellite's antenna array adjusted to cover a different physical location on the ground. When multiple iterations of the method 300 are performed with different beam configurations, data (e.g., measurements of the I/Q components) collected from the multiple iterations can be used to construct a model of the antenna pattern. The data collected from the multiple iterations may also help to characterize the edge of the beam (i.e., the point at which the gain decreases sharply).

In one example, the second instruction may provide an amount and/or direction in which to adjust the center of the beam. In another example, the second instruction may provide a physical location on the ground to which the processing system should focus the center of the beam.

In optional step 312 (illustrated in phantom), the processing system may adjust the center of the beam in response to the second instruction. Adjusting the center of the beam may cause a different physical location on the ground to be covered by the beam. Having adjusted the center of the beam created by the antenna array of the satellite, the method 300 may return to step 304, and the method 300 may proceed as described above to lock into the radio frequency test band and channel and to enter the co-channel receive mode with the center of the beam adjusted.

The processing system may continue to iterate through steps 304-312 unless or until the remote device instructs the processing system to exit the co-channel receive mode and cease locking into the radio frequency test band and channel.

FIG. 4 illustrates a flowchart of an example method 400 for characterizing satellite beams via passive measurement of terrestrial traffic, in accordance with the present disclosure. In one example, the method 400 may be performed by a user endpoint device in a terrestrial network, such as one of the user endpoint devices 106 or 108 illustrated in FIG. 1. However, in other examples, the method 400 may be performed by another device, such as the processor 502 of the system 500 illustrated in FIG. 5. For the sake of example, the method 400 is described as being performed by a processing system.

The method 400 begins in step 402. In step 404, the processing system may receive, from a remote device in a terrestrial network, a first instruction to lock into a radio frequency test band and channel.

In one example, the processing system may be part of a user endpoint device in the terrestrial network, where the user endpoint device may be any subscriber/customer endpoint device configured for wireless communication, such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like.

In one example, the radio frequency test band comprises a radio frequency band that is licensed by a mobile network operator who operates the terrestrial network. As discussed in further detail below, the radio frequency test band may also be utilized by a non-terrestrial network, such as a cellular-to-satellite NTN.

In one example, the terrestrial network may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, the terrestrial network may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G and further generations.

In one example, the remote device in the terrestrial network may comprise a network element management system or application server of a mobile network operator core network.

In step 406, the processing system may lock into the radio frequency test band and channel in response to the first instruction. In one example, “locking” of the processing system into the radio frequency test band involves “listening,” by the processing system, for signals that are broadcast in the radio frequency test band.

In step 408, the processing system may receive, from the remote device, a second instruction to initiate a continuous upload data stream to a base station of the terrestrial network. In one example, the second instruction indicates that the processing system should initiate the continuous upload data stream while the processing system is locked into the radio frequency test band and channel.

In step 410, the processing system may initiate the continuous upload data stream in response to the second instruction. In one example, the continuous upload data stream may be initiated using any one or more known communication protocols to establish a data transfer session. In a further example, the continuous upload data stream may comprise at least one of: a voice session or a data session. For instance, the continuous upload data stream may involve a voice call, a data (e.g., multimedia) call, a data (e.g., video, audio, or the like) streaming session, a data transfer (e.g., multimedia download) session, and/or another type of data transfer session.

In one example, a duration of the continuous upload data stream may be dynamically controlled by the processing system to be of sufficient length to maintain at least a threshold data rate over the connection to the terrestrial network over the duration of the continuous upload data stream (where the threshold data rate may comprise an average data rate over the continuous upload data stream, a peak data rate, a minimum data rate, or the like). In another example, the duration of the continuous upload data stream may be predefined, in which case the duration may be a duration that is empirically determined to be of sufficient length to maintain at least the threshold data rate over the connection to the terrestrial network over the duration of the continuous upload data stream. In another example, the duration of the continuous upload data stream may be determined to last for a predefined period of time after a satellite of an NTN that is sharing the radio frequency band has passed overhead.

In another example, the complexity of the continuous upload data stream may be controlled by the processing system to ensure that the data rate of the continuous upload data stream at least meets the threshold data rate over the connection to the terrestrial network over the duration of the continuous upload data stream. For instance, the continuous upload data stream may favor more bitrate intensive applications, such as streaming of higher quality (resolution) video, over less bitrate intensive applications, such as streaming of lower quality video.

In one example, the continuous upload data stream may be automated to repeatedly upload a specified file, such as a test file of a defined size, using randomized data to prevent the automatic application of data compression techniques (which would reduce the demand on the connection to the terrestrial network). The method 400 may end in step 412.

In one example, the method 400 may end in response to the processing system receiving an instruction from the remote device to cease the transmission of the continuous upload data stream. This may cause the processing system to cease transmitting the continuous upload data stream to the base station.

Although not expressly specified above, one or more steps of the method 200, method 300, or method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2, FIG. 3, or FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 200, method 300, or method 400 may be implemented as the system 500. For instance, an application server (such as might be used to perform the method 200, a satellite (such as might be used to perform the method 300, or a user endpoint device (such as might be used to perform the method 400) could be implemented as illustrated in FIG. 5.

As depicted in FIG. 5, the system 500 comprises a hardware processor element 502, a memory 504, a module 505 for characterizing satellite beams via passive measurement of terrestrial traffic, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for characterizing satellite beams via passive measurement of terrestrial traffic may include circuitry and/or logic for performing special purpose functions relating to indirectly estimating the coverage of a beam created by an antenna array of a satellite. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for characterizing satellite beams via passive measurement of terrestrial traffic (e.g., a software program comprising computer-executable instructions) can be loaded into memory 504 and executed by hardware processor element 502 to implement the steps, functions or operations as discussed above in connection with the example method 200, example method 300, or example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
sending, by a processing system including at least one processor to a satellite of a non-terrestrial network, a first instruction that instructs the satellite to lock into a radio frequency test band and channel as the satellite is passing over a testing area and to enter a co-channel receive mode;
sending, by the processing system to a user endpoint device that is physically located in the testing area, a second instruction that instructs the user endpoint device to lock into the radio frequency test band and channel and to initiate a continuous upload data stream to a base station of a terrestrial network while locked into the radio frequency test band and channel;
determining, by the processing system, a measurement of an in-phase/quadrature component of the continuous upload data stream observed by the satellite while the satellite was in the co-channel receive mode;
determining, by the processing system, a measurement of the in-phase/quadrature component of the continuous upload data stream observed by the base station;
correlating, by the processing system, the in-phase/quadrature component observed by the satellite with the in-phase/quadrature component observed by the base station; and
calculating, by the processing system, an estimated link loss of the non-terrestrial network and a change in a gain of an antenna of the satellite based on the correlating.

2. The method of claim 1, wherein the testing area comprises a defined physical location within a mobile network operator core network.

3. The method of claim 1, wherein the user endpoint device comprises at least one of: a laptop computer, a wi-fi device, a personal digital assistant, a mobile phone, a smartphone, an email device, a computing tablet, a messaging device, a wearable smart device, a gaming console, a drone, or an autonomous vehicle.

4. The method of claim 1, wherein the continuous upload data stream comprises at least one of: a voice session or a data session.

5. The method of claim 1, wherein the continuous upload data stream involves at least one of: a voice call, a data call, a data streaming session, or a data transfer session.

6. The method of claim 1, wherein the measurement of the in-phase/quadrature component of the continuous upload data stream observed by the satellite is acquired from at least one of: the satellite, a satellite receiver of the terrestrial network that is communicatively coupled to the satellite, or the base station of the terrestrial network that is communicatively coupled to the satellite.

7. The method of claim 1, wherein the measurement of the in-phase/quadrature component of the continuous upload data stream observed by the base station is acquired from at least one of: the user endpoint device or a log of the base station.

8. The method of claim 1, wherein the measurement of the in-phase/quadrature component of the continuous upload data stream observed by the base station is acquired from a device log of the user endpoint device.

9. The method of claim 1, wherein the measurement of the in-phase/quadrature component of the continuous upload data stream observed by the base station is acquired via an over-the-air transmission from the user endpoint device.

10. The method of claim 1, wherein the correlating comprises aligning the in-phase/quadrature component observed by the satellite with the in-phase/quadrature component observed by the base station based on time.

11. The method of claim 10, wherein the calculating is based on a comparison of an amplitude of the in-phase/quadrature component observed by the satellite with an amplitude of the in-phase/quadrature component observed by the base station at a same time.

12. The method of claim 1, further comprising:
sending, by the processing system to the satellite, a third instruction to adjust a center of a beam emitted by an antenna array of the satellite; and
subsequent to the satellite adjusting the center of the beam, repeating, by the processing system, the sending the first instruction, the sending the second instruction, the determining the measurement of the in-phase/quadrature component of the continuous upload data stream observed by the satellite, the determining the measurement of the in-phase/quadrature component of the continuous upload data stream observed by the base station, the correlating, and the calculating.

13. The method of claim 12, further comprising:
constructing, by the processing system a model of a pattern of the beam emitted by the antenna array of the satellite, based on the link budget loss as estimated over at least two iterations of: the sending the first instruction, the sending the second instruction, the determining the measurement of the in-phase/quadrature component of the continuous upload data stream observed by the satellite, the determining the measurement of the in-phase/quadrature component of the continuous upload data stream observed by the base station, the correlating, and the estimating.

14. The method of claim 13, wherein the constructing is performed using a machine learning technique.

15. The method of claim 1, wherein the processing system is a component of a network element management system.

16. The method of claim 1, wherein the estimating is performed without requiring the satellite to broadcast a transmit beam to ground.

17. The method of claim 1, wherein a center of a gain pattern of an antenna array of the satellite is earth-fixed.

18. The method of claim 1, wherein a beam of radio frequency energy created by an antenna array of the satellite sweeps across a physical area that includes the testing area.

19. A non-transitory computer-readable medium storing instructions which, when executed by a processing system including at least one processor, cause the processing system to perform operations, the operations comprising:
sending, to a satellite of a non-terrestrial network, a first instruction that instructs the satellite to lock into a radio frequency test band and channel as the satellite is passing over a testing area and to enter a co-channel receive mode;
sending, to a user endpoint device that is physically located in the testing area, a second instruction that instructs the user endpoint device to lock into the radio frequency test band and channel and to initiate a continuous upload data stream to a base station of a terrestrial network while locked into the radio frequency test band and channel;
determining a measurement of an in-phase/quadrature component of the continuous upload data stream observed by the satellite while the satellite was in the co-channel receive mode;
determining a measurement of the in-phase/quadrature component of the continuous upload data stream observed by the base station;
correlating the in-phase/quadrature component observed by the satellite with the in-phase/quadrature component observed by the base station; and
calculating an estimated link loss of the non-terrestrial network and a change in a gain of an antenna of the satellite based on the correlating.

20. A device comprising:
a processing system including at least one processor; and
a computer-readable medium storing instructions which, when executed by the processing system, cause the processing system to perform operations, the operations comprising:
sending, to a satellite of a non-terrestrial network, a first instruction that instructs the satellite to lock into a radio frequency test band and channel as the satellite is passing over a testing area and to enter a co-channel receive mode;
sending, to a user endpoint device that is physically located in the testing area, a second instruction that instructs the user endpoint device to lock into the radio frequency test band and channel and to initiate a continuous upload data stream to a base station of a terrestrial network while locked into the radio frequency test band and channel;
determining a measurement of an in-phase/quadrature component of the continuous upload data stream observed by the satellite while the satellite was in the co-channel receive mode;
determining a measurement of the in-phase/quadrature component of the continuous upload data stream observed by the base station;
correlating the in-phase/quadrature component observed by the satellite with the in-phase/quadrature component observed by the base station; and
calculating an estimated link loss and a change in a gain of an antenna of the satellite of the non-terrestrial network based on the correlating.
